(19) United States
(12) Patent Application Publication
(10) Pub. No.: US 2010/0271559 A1
(43) Pub. Date: Oct. 28, 2010

(54) NETWORK ACCESSIBLE DISPLAY

(75) Inventor: Geoffery Martin, Scotts Valley, CA (US)

Correspondence Address: Patent Venture Group, 10788 Civic Center Drive, Suite 215, Rancho Cucamonga, CA, 91730-3805, US

(73) Assignee: DIGITAL DELIVERY NETWORKS, INC., Scotts Valley, CA (US)

(21) Appl. No.: 12/630,310

(22) Filed: Dec. 3, 2009

Related U.S. Application Data
(60) Provisional application No. 61/119,695, filed on Dec. 3, 2008.

(51) Int. Cl. H04N 5/44; H04N 5/66

(52) U.S. Cl. 348/734; 348/739; 348/E05.096; 348/E05.133

(57) ABSTRACT

An apparatus for playing visual content and audio content to a user. A display screen is provided that is physically integrated into the apparatus. A video-image processing circuit is provided to play visual content on the display screen and an audio processing circuit is provided to play audio content on one or more speakers that are physically integrated into or externally connected to the apparatus. In the respects stated so far, the apparatus may resemble a monitor (including but not necessarily a computer monitor) or a television. In particular, a communications circuit is further provided to wirelessly connect the apparatus to a local area network to receive instances of the visual content and audio content via the local area network for playback to the user by the apparatus.

### CROSS-REFERENCE TO RELATED APPLICATIONS

This application claims the benefit of U.S. Provisional Application No. 61/119,695, filed Dec. 3, 2008.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to video display units such as televisions and monitors (including but not limited to computer monitors), and more particularly to communicating video-image content and optionally also audio content to such video display units for playback.

2. Background Art

The variety of electronic systems in the modern household continues to grow. FIG. 1 (background art) is a schematic block diagram that stylistically depicts this and how a common problem with this now is a divide 10 between such electronic systems 12. Generally, on one side of this divide 10 are traditional television related systems (called TTV systems 14 herein) and on the other side are personal and house-wide computerized systems (called P/H systems 16 herein). As now discussed, a problem in this is that there is essentially no communications across the divide 10 between TTV systems 14 and P/H systems 16.

Turning first to the TTV systems 14, the predominant end-user device here is a television 18, with FIG. 1 showing three in a representative household. For the sake of this example a first television 18a is located in a recreation room, a second television 18b is located in a master bedroom, and a third television 18c is located in a garage.

The first television 18a is a big screen, high definition plasma unit (say, a 52″ screen, 1080 native resolution, 120 Hz unit presently costing US$2,500). To facilitate operation of the first television 18a, the user employs a remote controller 20 (here a first remote controller 20a). Of particular importance herein, the first television 18a in our hypothetical household is connected to a service box 22 (here a first service box 22a) that is connected to a service portal 25 (described in more detail presently). Of further importance, this first service box 22a has an integrated digital video recorder (DVR unit 24) and a set of network ports 26. And in typical manner, the first remote controller 20a here additionally is used to control the first service box 22a and the DVR unit 24.

The second television 18b is a medium size LCD unit (say, a 40″ screen, 720 native resolution unit presently costing US$1,000). Also of importance for what follows, the second television 18b is connected to a second service box 22b that is also connected to the service portal 25 and a separate digital video disk player (DVD player 28, here generically representing any of video tape players, laserdisc players, conventional DVD players, HD-DVD players, Blu-ray (TM) disc players, etc.) is connected between the second television 18b and the second service box 22b. The user here employs a second remote controller 20b to control all of the second television 18b, the second service box 22b, and the DVD player 28.

The third television 18c is a near antique. It is a 10-year old picture tube based unit with a “rabbit ears” antenna and might fetch US$50 at a yard sale, but its owner keeps it in the garage to occasionally watch baseball games or soap operas when waxing the car. The third television 18c is manually controlled (no remote controller) and it is not connected to the service portal 25.

The equipment in the TTV systems 14 thus performs entertainment functions, playing video content on the televisions 18, with the other equipment here providing communications to support this.

Turning next to the P/H systems 16, there is no predominant end-user device here but this equipment can collectively be viewed as having many “brain” like functions, including logic-based processing, data storage, and communications handling capability. As can be seen in FIG. 1, our hypothetical household has a personal computer (PC 30), a laptop computer 32, a personal digital assistant (PDA 34, say, an iPhone (TM)), a network accessible storage unit (NAS 36), and a home kiosk 38 that centrally controls various home utility systems (e.g., alarm, timed lawn sprinklers, exterior lighting, etc.). To facilitate the use of these the household has a local area network (LAN 40) that here further includes a router 42 (one having both wired port and WiFi capabilities here). The router 42 is connected to a high speed modem 44 that in turn connects in some manner to the Internet 46. The PC 30, NAS 36, and home kiosk 38 are wire-connected to the router 42 (e.g., using a 10/100/100 Ethernet protocol) and the laptop computer 32 and PDA 34 are radio frequency WiFi-connected to the router 42 (e.g., using the IEEE 802.11g protocol; WiFi is short for “Wireless Fidelity”). The high speed modem 44 might be a DSL or other high speed communications modem but, for the sake of this particular example it is a cable modem that is physically connected to the same service portal 25 as all of the service boxes 22.

In the P/H systems 16 the brain-like functionalities are very powerful, being flexibly configurable, distributable, extendable, etc. For example, the logic-based processing functionality of the PC 30, laptop computer 32, or even the PDA 34 can be applied to virtually any task where data for that task can be communicated to and from these devices. The home kiosk 38 also has logic-based processing and, although typically dedicated to home utility control tasks, there is no inherent reason for this limitation and the utility control tasks performed by the home kiosk 38 might instead, for instance, be performed by the PC 30 when it is turned on. Similarly, the data storage functionality among the P/H systems 16 is noteworthy, being especially distributable and extendable. For example, a spreadsheet prepared on the PC 30 can be moved to the laptop computer 32 or a grocery list accumulated at the home kiosk 38 can be copied to the PDA 34. Our household members here also may have extensive multimedia collections (e.g., photographs, home videos, purchased music recordings, etc.) stored as files in the PC 30, laptop computer 32, or especially in the NAS 36. These are also easily moved or copied across the LAN 40 and, if these collections grow, more storage capacity can easily be added, say, in the NAS 36 or the PC 30. In particular however, it should be observed that all of the P/H systems 16 here can communicate across the LAN 40 and via it onto and across the Internet 46.

The problem in all of this, unfortunately, is that the P/H systems 16 generally cannot communicate with the TTV systems 14 because the TTV systems 14 will not “listen.” Even though the service boxes 22 and the modem 44 here in this example are physically connected to the very same service portal 25 via cable, the service boxes 22 typically are configured by their providers to “listen” only to what those service providers send as instructions or entertainment content. Thus, if a member of our hypothetical household has an AVI format video file stored on the NAS 36 they typically cannot play this on the big screen of the first television 18a. Or if another member of our hypothetical household has a MP3 audio file stored in the PDA 34 they cannot play this on the speakers of the second television 18b in the master bedroom. While especially the first television 18a and even the second television 18b represent substantial financial investments, each quite possibly costing more than any single unit among the P/H systems 16, access to the televisions 18 is effectively held hostage by the cable/satellite service providers of the service boxes 22 or else is not technically practical.

To say that cable/satellite service providers hold their customers “hostage” may seem overly blunt, but it is all to often true today. Most cable and satellite services are monopolies, either outright or effectively, and television owners that want cable or satellite service rarely have more than two or three suspiciously similar choices. In the case of cable service, a municipality or some other regional government entity usually enforces a geographically defined monopoly, selling the “cable rights” in that region to a single service provider. Similarly, satellite service today is effectively a monopoly because of the very high capital investment required to provide satellite based service and in the United States, for instance, there are effectively only two satellite service choices currently available.

As a result of this situation, the service boxes 22 shown in FIG. 1 are usually proprietary, at least in their programming and often in their very circuitry, to work with content only from a particular service provider. Television owners thus usually have to lease a service box 22 for every television they have, even if these are so-called “cable ready” televisions. Related to this proprietary nastiness, the network ports 26 shown on the first service box 22a represent a typical case that many technically savvy owners of P/H systems 16 today find very frustrating. Almost all modern service boxes 22 have at least one conventional network port of some kind, and many have a variety of such. For instance, the most widely provided service boxes 22 today all have at least one IEEE 1394 “Firewire” port, multiple USB ports, and an Ethernet port—all of which are either turned off or otherwise rendered un-usable for an end-user to connect to essentially anything. Granted, a stand alone computer-type disk drive can be connected to the USB ports of some service boxes 22, but this then becomes essentially a dedicated upgrade of the service box because the drive must be re-formatted using a proprietary scheme by the service box before use.

Thus, as some additional examples, a member of our hypothetical household in FIG. 1 may have a photograph in the PDA 34 but there is no practical way they can view that photograph on the US$2,500 first television 18a. Or a member of our hypothetical household may be watching the second television 18b in the bedroom and observe that it is raining heavily outside, but there is no way that they can use the second television 18b as a display and the second remote controller 20b as an input unit in place of the home kiosk 38 in the kitchen to turn off the lawn sprinklers. In sum, the divide 10 is a substantial barrier to using the variety of electronic systems 12 in the modern household.

Before concluding here with FIG. 1 it should further be appreciated that this problem goes beyond just that of communicating across the divide 10 between the TTV systems 14 and the P/H systems 16. With very limited exceptions now being introduced by cable/satellite service providers in service boxes 22 offered in a few major markets, even among TTV systems 14 there typically is no “cross-branch” communications. For example, a sub-divide 48 separates the first service box 22a, DVR unit 24, and first television 18a as a group from the second service box 22b, DVD player 28, and second television 18b as a group. A user today therefore generally cannot play a program recorded on the DVR unit 24 on the second television 18b or play a Blu-ray (TM) disc in the DVD player 28 on the first television 18a. Similarly, another sub-divide 50 separates the third television 18c from all of the rest of the TTV systems 14.

Accordingly, what is need is a system to bridge at least the divide 10 between the TTV systems 14 and the P/H systems 16, and additionally to bridge the sub-divides 48, 50 among groupings of TTV systems 14.

Turning away now from the problem towards the inventor's solution for it, it should be noted that many aspects of the underlying display technologies involved here are conventional. In the interest of summarizing some major aspects of this and establishing some of the terminology that is used herein, the following additional background information is provided.

FIGS. 2a-b (background art) are of a video display unit (VDU 60), wherein FIG. 2a is a front view and FIG. 2b is a left side cut-away view showing major representative functional elements of the VDU 60 in a highly stylized manner.

Starting with FIG. 2a, this generally depicts how a user or viewer perceives the VDU 60.

Other than a housing or cabinet 62, the salient visual feature of the VDU 60 here is the front of a display screen 64 that displays images. The images may be single or “still” images (hereinafter “image content”), but more typically these are related sets of images that are perceived as video or moving pictures (hereinafter “video content”; and hereinafter “visual content” when either content can be applicable). The salient audible feature of the VDU 60 here is one or more speakers 66 that play sounds (two in a simple stereo arrangement are shown). The sounds usually are sequences of many sounds (hereinafter “audio content”) that typically (but not necessarily) are in some way related to visual content being presented on the display screen 64 of the VDU 60. A less prominent feature of the VDU 60 is a set of controls 68 that a user can use to change the various functions of the VDU 60 (e.g., powering it on or off, selecting what visual and/or audio content is played, and setting playback characteristics for such content, like color balance, volume, etc.). Historically the various controls 68 of early VDUs 60 operated manually, and most VDUs 60 still have at least limited capability for this, but the overwhelming case today is to employ a remote controller 70 to remotely and wirelessly operate the controls 68.

Turning now also to FIG. 2b, this generally depicts the major functional sections of the

VDU 60. The cabinet 62, display screen 64, speakers 66, controls 68, and remote controller 70 are all again shown. Additionally shown here are a power section 72, a signal receiver section 74, a video-image processing section 76, an audio processing section 78, and a controlling section 80. The power section 72 is physically connected to an external power source (not shown) to receive and distribute power as needed throughout the VDU 60. The signal receiver section 74 is physically connected to an external signal source (not shown) to receive visual and audio content, and to distribute it to the video-image processing section 76 and the audio processing section 78. Although many modern VDUs 60 can receive visual content and audio content as separate signals, most commonly these are received as an integrated signal (often also with an ability to select among individual or multiple such integrated signals provided from multiple external signal sources), and the signal receiver section 74 here is therefore depicted as a single unit. The video-image processing section 76 processes the received visual content as needed to present it on the display screen 64. Depending on the nature of how the visual content is received as a signal and on how a user of the VDU 60 wants to view this content, this can entail considerable work and sophisticated circuitry but this is not particularly relevant here. Similarly, the audio processing section 78 process the received audio content as needed to present it on the speakers 66. And also similarly, depending on the nature of how the audio content is received as a signal and how a user of the VDU 60 wants to perceive it, this also can entail considerable work and sophisticated circuitry but this also is not particularly relevant here. The controlling section 80 controls all of this functionality, subject to established default settings or changes made by a user with the controls 68. The controlling section 80 will vary in capability and the circuitry used for this, depending on the designed purpose of the VDU 60.

The reader by now has probably observed that the generic VDU 60 just described resembles a monitor or a television. [As an aside, the term “computer monitor” is herein avoided because this unduly implies use only with a computer.] Both monitors and televisions are, of course, major classes of VDUs 60.

Historically, monitors have not included speakers or an audio processing section. But this is no longer always the case. Some monitors today do include speakers or a capability to attach them as an option, and some monitors today include an audio processing section to provide audio content to such speakers. Furthermore, some VDU manufacturers now market monitors (often “computer monitors”) as being television-capable. With reference briefly back to FIG. 1, many examples of monitors as VDUs 60 are shown there. For instance, all of the PC 30, laptop computer 32, PDA 34, and home kiosk 38 have monitor-type VDUs 60.

Televisions are VDUs 60 that are particularly characterized by having a tuning capability in their signal receiver section 74, to permit reception of and selection (via the controlling section 80) among multiple channels of visual and audio content. Early televisions received “television channels” (signals with integrated video and audio content) that were broadcast by radio waves). An antenna was the external signal source used to receive this and provide it to the signal receiver section, where tuning to a particular channel ensued. A major evolutionary enhancement of this was the advent of cable distribution of television channels, which continues today also with satellite distribution now being common. In the cases of both cable and satellite television channel distribution, however, the underlying television remains essentially the same. With reference again briefly back to FIG. 1, it can now be observed that the televisions 18a-c there are all examples of television-type VDUs 60.

### BRIEF SUMMARY OF THE INVENTION

Accordingly, it is an object of the present invention to provide a network accessible display.

Briefly, one preferred embodiment of the present invention is a network accessible display. A video display unit including a display screen, a video-image processing circuit, an audio processing circuit, and a controlling circuit is provided. The video-image processing circuit plays visual content on the display screen and the audio processing circuit plays audio content on one or more speakers that are physically integrated into or externally connected to the video display unit. The controlling circuit directs functions of the video display unit. And a communications circuit is further provided to wirelessly connect the video display unit to a local area network to receive the visual and audio content for playback with the video display unit.

Briefly, another preferred embodiment of the present invention is an improved television of the type in which a video-image processing circuit plays visual content on an integrated display screen and an audio processing circuit plays audio content on one or more integrated or externally connected speakers and a controlling circuit directs functions of the television. The improvement comprises a communications circuit integrated into the television to wirelessly connect to a local area network to receive the visual content and the audio content via said local area network for playback by the television.

And briefly, another preferred embodiment of the present invention is a communications circuit to connect a video display unit to a local area network to receive visual content and audio content for playback. A wireless fidelity (WiFi) type receiver is provided to wirelessly receive the visual and audio content from the local area network. Interface circuitry is provided to communicate the visual and audio content from the communications circuit to the video display unit. And a processor and a logic running therewith are provided that controllably receive the visual and audio content and play it back with the video display unit.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 (background art) is a schematic block diagram that stylistically depicts how a divide, and potentially also sub-divides, exist between electronic household systems.

FIGS. 2a-b (background art) are of a video display unit (VDU), wherein FIG. 2a is a front view and FIG. 2b is a left side cut-away view showing major representative functional elements of the VDU in a highly stylized manner.

FIG. 3 is a schematic diagram depicting a first embodiment of a network accessible display (NAD) in use, wherein the NAD is in accord with the present invention.

FIG. 4 is a schematic diagram depicting second and third embodiments of NADs in use, wherein both NADs here are also in accord with the present invention.

FIG. 5 stylistically shows how the communications circuit used in the NAD in FIG. 3 may be added to the VDUs in FIGS. 2a-b or to the first television in FIG. 1.

FIG. 6 is a schematic block diagram that stylistically shows a communications circuit and how it is integrated into a VDU in a NAD.

FIG. 7 is a schematic block diagram that stylistically shows an alternate communications circuit and the manner in which it can be externally connected to a VDU in a NAD.

FIG. 8 is a schematic block diagram that stylistically shows yet an alternate communications circuit and the manner in which it can be externally connected to a VDU in a NAD.

In the various figures of the drawings, like references are used to denote like or similar elements or steps.

### DETAILED DESCRIPTION OF THE INVENTION

A preferred embodiment of the present invention is a network accessible display (NAD). This is illustrated in the various drawings herein, and particularly in the views of FIGS. 3-4, wherein embodiments of the invention are depicted by the general reference character 100.

Briefly and very basically, the inventive NAD 100 is essentially a conventional video display unit to which a communications circuit 102 has been added.

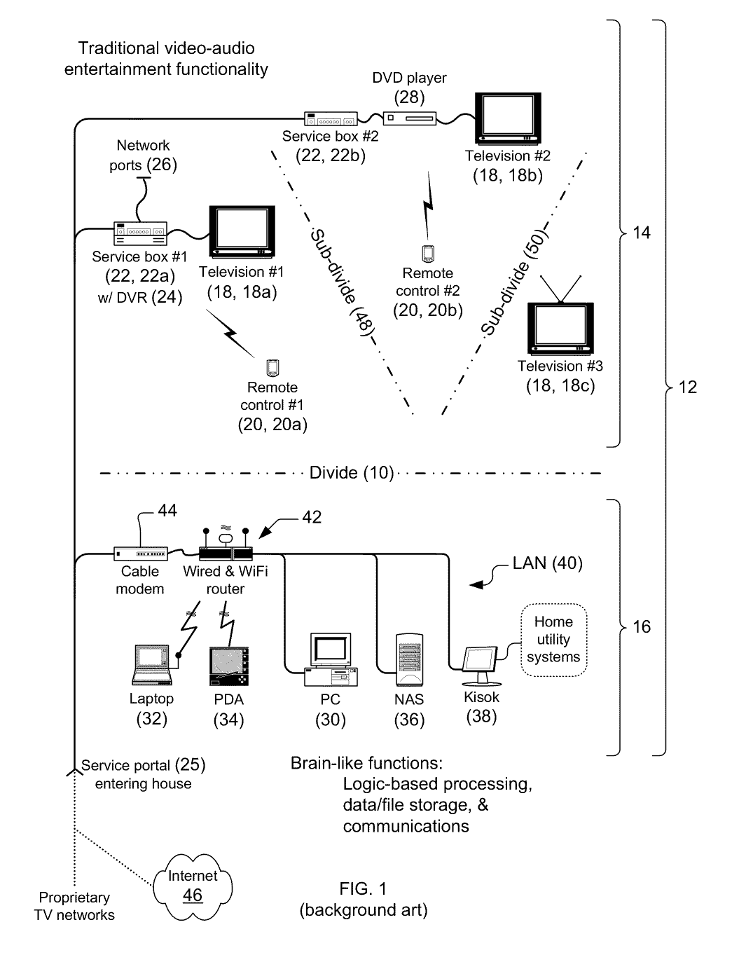

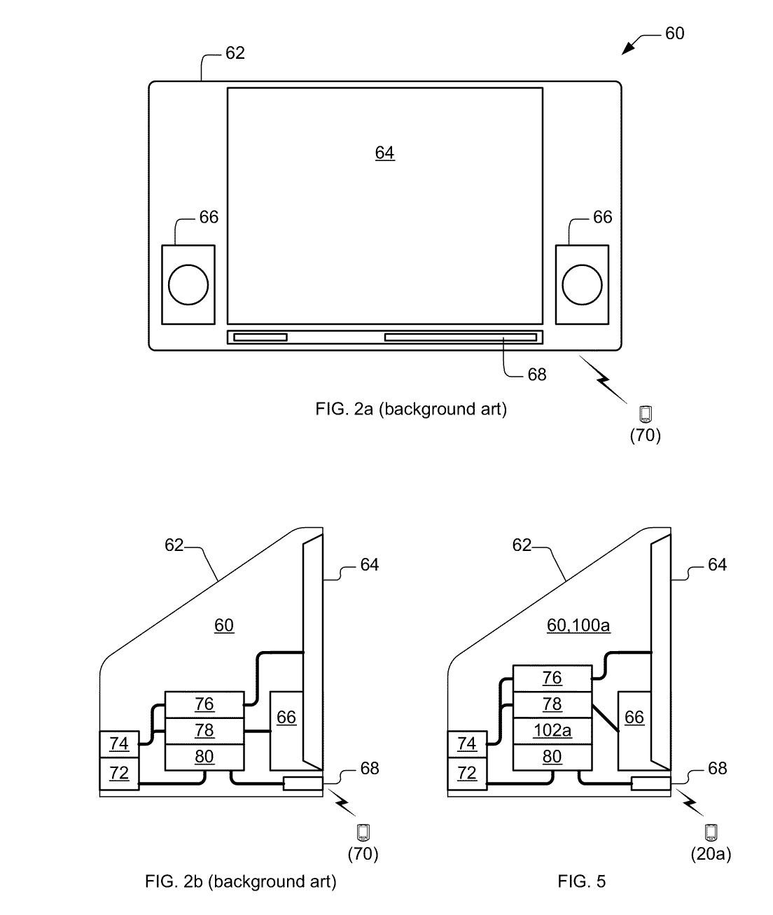

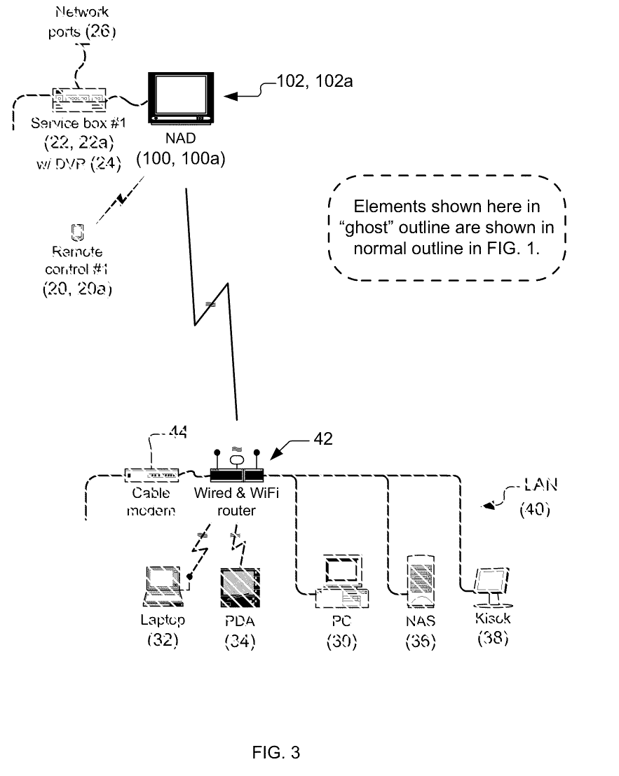

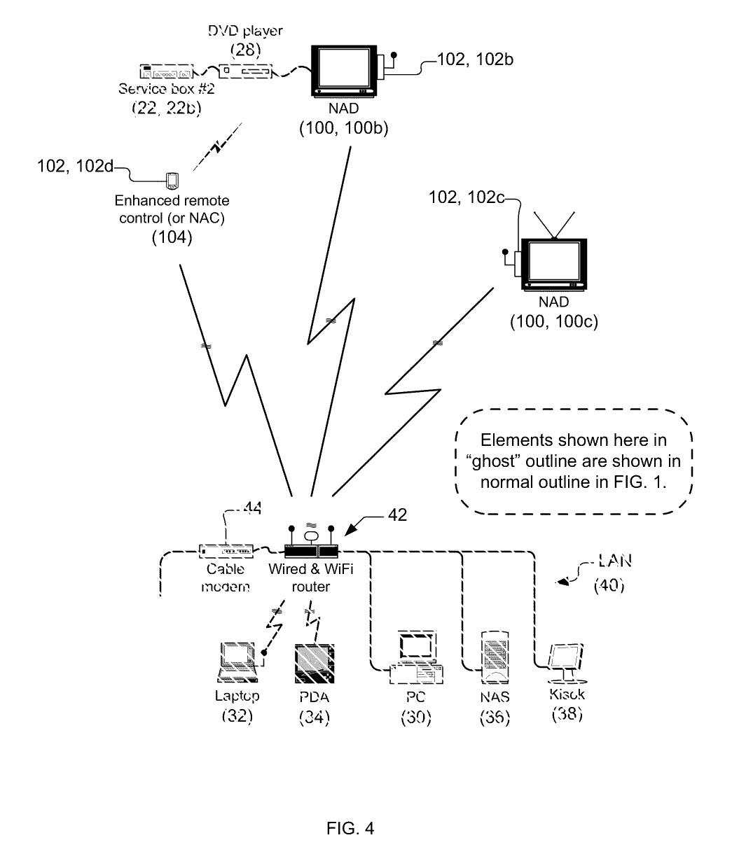

FIG. 3 is a schematic diagram depicting a NAD 100 in use (NAD 100a for this specific embodiment). Here the NAD 100a is intentionally depicted as being the first television 18a of FIG. 1, with the communications circuit 102 added internally (communications circuit 102a for this specific embodiment). The communications circuit 102a wirelessly connects the NAD 100a to a router 42 (FIG. 1) in a local area network (LAN 40) to receive visual and audio content for playback to a user of the NAD 100a. Since the communications circuit 102a here is integrated into the NAD 100a, a conventional remote controller (such as the first remote controller 20a) is also usable to control all of the functionality of the NAD 100a.

FIG. 4 is a schematic diagram depicting two other NADs 100 in use (NAD 100b and NAD 100c for these embodiments). Here the NADs 100b-c are shown as being the second television 18b and the third television 18c of FIG. 1, with the communications circuits 102 added externally here (communications circuit 102b and communications circuit 102c for these embodiments). The communications circuits 102b-c wirelessly connect the NADs 100b-c (i.e., televisions 18b-c) to the router 42 in the LAN 40 to receive visual and audio content for playback to a user of the NADs 100b-c (televisions 18b-c). [Note, the communications circuits 102b-c here are stylistically depicted as sizable units with antennas. In actual embodiments, however, the communications circuits 102b-c can be substantially smaller and have antennas that are totally integrated into the physical unit to the point that they are not noticeable.]

Since the communications circuit 102b here is external to the NAD 100b, a conventional remote controller like the second remote controller 20b (FIG. 1) may or may not be usable to directly control the functionality of the NAD 100b. The second remote controller would, of course, still controls the basic functionality of the second television 18b (and devices related to it like the second service box 22b and the DVD player 28), but whether it can also control the communications circuit 102b here is another matter.

First, because the externally added communications circuit 102b here typically will not be able to control the second television 18b (e.g., change speaker volume, etc.), the communications circuit 102b of the NAD 100b here will likely have to appear to a conventional remote controller as an additional device being controlled. In the scenario depicted in FIG. 4 that would bring the “count” of devices being controlled up to four, making for a more complex than typical remote controller and one that would be somewhat more complicated for a user to learn and operate. It is therefore expected that this approach will be adopted for existing VDUs (e.g., televisions already in homes), but eventually become less important in the market as NADs 100 with internal communications circuits like the communications circuit 102a in FIG. 3 become common.

There is also a second reason that using a conventional remote controller with an externally added communications circuit, like the communications circuit 102b here in FIG. 4, may be awkward or impractical. It should be recalled that conventional remote controllers use infrared light beam technology and can generally only control systems in their “line of sight.” This will accordingly require that the communications circuit 102b be optically controllable (in addition to its inherent radio frequency capability) and further that at least part of the communications circuit 102b will have to be placed at the front of the NAD 100b or in some other “line of sight” position relative to a viewer of the second television 18b. If a television to be turned into a NAD 100b already has front ports to accept video input, the communications circuit 102b may be added there but this has potential disadvantages, such as being un-aesthetic, making the communications circuit 102b more easily subject to physical damage, and obscuring or interfering with other controls of the television 18b.

Digressing briefly, it should also be recalled that the old third television 18c in the garage in the scenario in FIG. 1 has no remote control capability whatsoever. But if that third television 18c is to be converted into the NAD 100c, it obviously is highly desirable to have this NAD 100c be remotely controllable and able to communicate with devices on or accessible via the LAN 40 (i.e., to communicate bi-directionally). For instance, if a user wanted to watch a video file it would be awkward to have to go into the house to the PC 30, set it up to stream the file from the NAS 36 to the NAD 100c, and then return to the garage to actually watch the video file.

FIG. 4 additionally depicts a solution to the problems just described. Rather than use a conventional optical-only remote controller, an enhanced remote controller 104 can be employed that has its own communications circuit 102d that uses radio frequency communications. In the same manner that the communications circuits 102 add a NAD 100 to the LAN 40 as another network accessible device (e.g., using an IEEE 802.11x protocol, having its own local IP address, etc.), the communications circuit 102d here turns the enhanced remote controller 104 into a network accessible device (albeit a “network accessible controller” or “NAC” here). In addition to permitting control of the communications circuits 102b-c (and communications circuit 102a as well for that matter), this can also permit controlling any of the P/H systems 16 from anywhere within the WiFi range of the router 42.

Turning next to FIG. 5, this stylistically shows how the communications circuit 102a may be added to the VDU 60 in FIGS. 2a-b or to the first television 18a of FIG. 1. [Again, FIGS. 2a-b and now also FIG. 5 represent functionality and not the necessary literal shape of the overall devices involved. For example, the VDU 60 in FIG. 2b physically more resembles a projection-type television in overall shape than a flat screen device, such as the first television 18a in FIG. 1.] In FIG. 5 the communications circuit 102a is shown as an additional circuit interposed between conventional sections of the VDU 60 (particularly including the video-image processing section 76, the audio processing section 78, and controlling section 80 of the NAD 100a here). This arrangement represents how the communications circuit 102a functionally can be separate from the signal receiver section 74 yet serve to provide visual content and audio content to the video-image processing section 76 and the audio processing section 78, as well as inter-communicate with the controlling section 80. A conventional remote controller, such as the first remote controller 20a of FIG. 1 again shown here, can be used to additionally control the communications circuit 102a itself, and via the communications circuit 102a and the router 42 and the LAN 40 (FIG. 3) to controllably access the brain-like functionalities (e.g., logic-based processing, data storage, and communications both across the LAN 40 and via it onto and across the Internet 46) of all of the available P/H systems 16 (e.g., FIG. 1).

Of course, the circuitry in VDUs 60 is typically much more integrated than what is shown in FIGS. 2a-b and 5, and various alternate arrangements of the circuitry are possible. But these should be essentially straightforward to one of ordinary skill in the art once the points discussed herein are grasped.

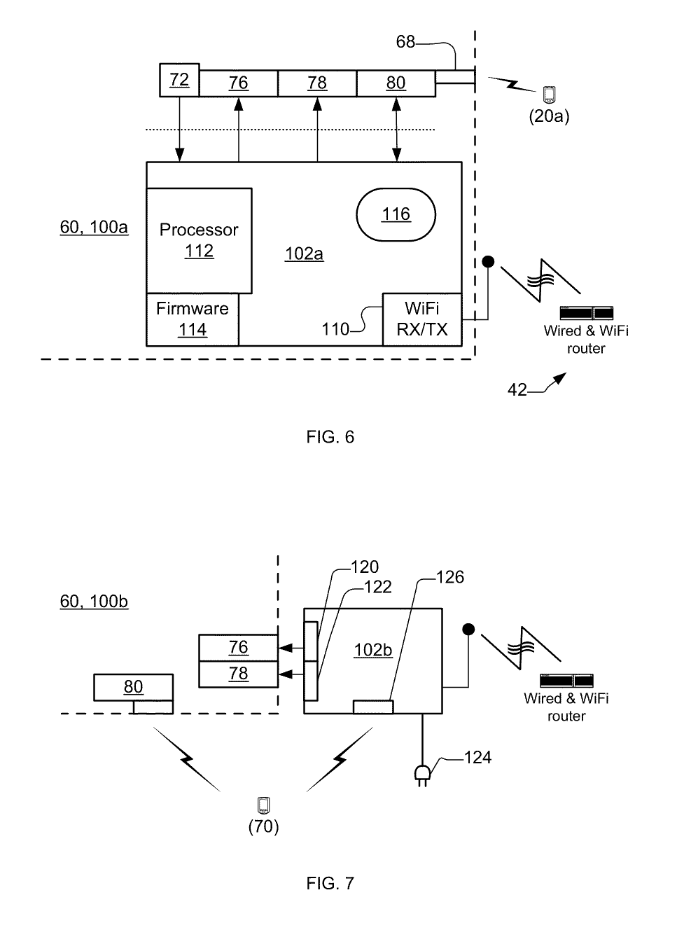

FIG. 6 is a schematic block diagram that stylistically shows the communications circuit 102a and how it is integrated into the VDU 60 in the NAD 100a here. The communications circuit 102a connects with all of the power section 72, video-image processing section 76, audio processing section 78, and controlling section 80. The communications circuit 102a receives power from the power section 72, provides video-image content to the video-image processing section 76, provides audio content to the audio processing section 78, and bi-directionally communicates with the controlling section 80. Since it is easy to connect the communications circuit 102a and the controlling section 80 in the integrated embodiment of the VDU 60 here, remote control type access to the communications circuit 102a is simply accomplished via the controls 68 and the controlling section 80 of the hosting VDU 60.

Once the overall inventive principles covered above are appreciated, the elements of the communications circuit 102a are largely straightforward. The major elements include a WiFi receiver 110 (here having an optional WiFi transmitting capability as well; Wi-Fi (TM) is short for “Wireless Fidelity” and is a radio communications protocol based on technology is based on IEEE 802.11 standards), a processor 112, logic 114 that controls the processor (here shown as firmware), and general interface circuitry 116.

FIG. 7 is a schematic block diagram that stylistically shows the communications circuit 102b and the manner in which it can be externally connected to the VDU 60 in the NAD 100b here. Here the NAD 100b has connections for external audio and visual content input (connections to the video-image processing section 76 and the audio processing section 78), so the communications circuit 102b has an audio port 120 and a video port 122 to communicate with these. Otherwise the communications circuit 102b here has generally the same elements as the communications circuit 102a in FIG. 6, with two particular exceptions. First, since the communications circuit 102b here is not easily able to be powered by the power section 72 of the VDU 60, the communications circuit 102b here has its own power source 124. Second, since the communications circuit 102b here does not have access to the controlling section 80 of the VDU 60, the communications circuit 102b here has its own remote control port 126 to receive instructions from a remote controller 70 (conveniently, the same remote controller 70 that also operates the controls 68 of the VDU 60, although this is not a requirement).

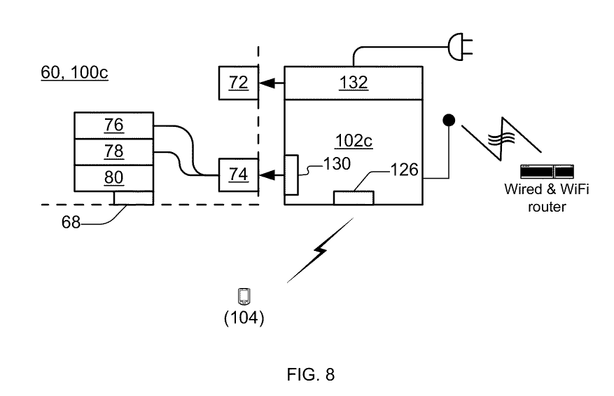

FIG. 8 is a schematic block diagram that stylistically shows the communications circuit 102c and the manner in which it can be externally connected to the VDU 60 in the NAD 100c here. Here the NAD 100c has no connections for external audio and visual content input, so the communications circuit 102c has an signal port 130 that provides video-image and audio content to the signal receiver section 74 of the NAD 100c. Similar to the case depicted in FIG. 7, the communications circuit 102c here has its own remote control port 126 to receive instructions from a remote controller (here the enhanced remote controller 104 shown in and discussed with FIG. 4, although this arrangement is also not a requirement). Finally, as a useful option, the communications circuit 102c here has a power section 132 that connects to a power source and that controls the power into the power section 72 of the NAD 100c. In this manner the enhanced remote controller 104 and the communications circuit 102c here can be used to power the NAD 100c on and off (recall that the NAD 100c here has no original remote control capability).

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A network accessible display, comprising:
a video display unit including a display screen, a video-image processing circuit, an audio processing circuit, and a controlling circuit;
said video-image processing circuit to play visual content on said display screen;
said audio processing circuit to play audio content on one or more speakers that are physically integrated into or externally connected to said video display unit;
said controlling circuit to direct functions of said video display unit; and
a communications circuit to wirelessly connect said video display unit to a local area network to receive said visual content and said audio content for playback with said video display unit.

2. The network accessible display of claim 1, wherein said display screen is a television screen.

3. The network accessible display of claim 1, wherein said communications circuit is physically integrated into said video display unit.

4. The network accessible display of claim 1, wherein said communications circuit is externally connected to said video display unit and provides said visual content and said audio content that is received to said video display unit.

5. The network accessible display of claim 1, wherein said communications circuit further operates said controlling circuit.

6. The network accessible display of claim 5, wherein said communications circuit further receives instructions from said local area network to operate said controlling circuit.

7. The network accessible display of claim 1, wherein said communications circuit further communicates information from said video display unit to said local area network.

8. The network accessible display of claim 1, further comprising a remote controller permitting a user of the network accessible display to remotely operate said controlling circuit.

9. The network accessible display of claim 8, wherein said communications circuit further receives instructions from said remote controller to operate said controlling circuit.

10. The network accessible display of claim 8, wherein said remote controller wirelessly operates said controlling circuit

11. The network accessible display of claim 10, wherein said remote controller wirelessly operates said controlling circuit with instructions sent via a member of the set comprising radio frequency waves and infrared light beams.

12. The network accessible display of claim 8, wherein said communications circuit and said remote controller communicate bi-directionally.

13. An improved television of the type in which:
a video-image processing circuit plays visual content on an integrated display screen;
an audio processing circuit plays audio content on one or more integrated or externally connected speakers; and
a controlling circuit that directs functions of the television;
the improvement comprising:
a communications circuit integrated into the television to wirelessly connect to a local area network to receive the visual content and the audio content via said local area network for playback by the television.

14. The television of claim 13, wherein said communications circuit further operates said controlling circuit.

15. The television of claim 14, wherein said communications circuit further receives instructions from said local area network to operate said controlling circuit.

16. The television of claim 13, wherein said communications circuit further communicates information from the television to said local area network.

17. The television of claim 13, further comprising a remote controller permitting a user to remotely operate said controlling circuit.

18. The television of claim 17, wherein said communications circuit further receives instructions from said remote controller to operate said controlling circuit.

19. The television of claim 17, wherein said remote controller wirelessly operates said controlling circuit.

20. The television of claim 19, wherein said remote controller wirelessly operates said controlling circuit with instructions sent via a member of the set comprising radio frequency waves infrared light beams.

21. The television of claim 17, wherein said communications circuit and said remote controller communicate bi-directionally.

22. A communications circuit to connect a video display unit to a local area network to receive visual content and audio content for playback, comprising:
a wireless fidelity type receiver to wirelessly receive the visual content and the audio content from the local area network;
interface circuitry to communicate the visual content and the audio content from the communications circuit to the video display unit; and
a processor and a logic running therewith that controllably receive the visual content and the audio content and playback the visual content and the audio content with the video display unit.
